(19) United States
(12) Patent Application Publication
(10) Pub. No.: US 2005/0274278 A1
(43) Pub. Date: Dec. 15, 2005

(54) Moving camera mount

(76) Inventor: Gary Thieltges, Los Angeles, CA (US)

Correspondence Address: David B. Abel;Squire, Sanders & Dempsey L.L.P., 801 S. Figueroa Street, 14th Floor, Los Angeles, CA, 90017-5554, US

(21) Appl. No.: 11/149,915

(22) Filed: Jun. 10, 2005

Related U.S. Application Data
(60) Provisional application No. 60/578,883, filed on Jun. 10, 2004.

(51) Int. Cl. G03B 15/00

(52) U.S. Cl. 104/292

(57) ABSTRACT

A rail and an associated moveable sled for mounting equipment for example to be used with a moving camera platform. The weight and rigidity of the rail along with its mounting capabilities allows the attachment of the rail to moving objects such as automobiles, as well as other mounting applications such as overhead, along walls or in tight spaces.

### BACKGROUND OF THE INVENTION

1. Field of the Invention

The present invention is directed to the field of movie camera mounting systems, although more generally the invention is directed to a light weight and highly rigid parallel rail track and slide or equipment platform sled system.

2. General Background and State of the Art

The current methods of moving and mounting cameras in the motion picture industry are numerous and varied. Dollies have been used to move cameras in order to provide a changing perspective for nearly 100 years. Cranes and arms have been devised to extend the reach of the move. Mounts on cars have been provided to be able to capture images from fixed positions on a moving car. Lightweight arms have been provided to place the camera at distances off the vehicle. These arms have been articulated so as to provide a radius of movement from a pivot point at the base. Individuals have made custom one-use rigs to provide movement to cameras in hundreds of situations.

The limitations of these various methods of moving cameras are various. Typical dolly methods are too heavy for many applications. The rails are not stiff enough to be self-supporting. Short rail systems have been provided that allow manual manipulation of cameras along short distances. Motorized versions of these tracks have been provided but are limited to a set length of travel and limited speed and mounting possibilities. The lightweight arms that pivot from the base do not provide significant change of perspective to the vehicle to which they are mounted.

### BRIEF SUMMARY OF THE INVENTION

The current invention provides a rail system for example to be used with a moving camera platform sled that overcomes numerous limitations of previous rail systems and mounting methods. The weight and rigidity of the rail system along with its mounting capabilities allows the attachment of the rail system to moving objects such as automobiles, as well as other mounting applications such as overhead, along walls or in tight spaces. A radio controlled, motorized sled or camera mount fixed on the rail system can provide operational control where the direct operation of a dolly is unfeasible, such as for a camera suspended overhead or on a traveling vehicle. The motorized sled, along with its precise controls, allow the exact positioning of the camera along the rail system, as well as precise control of the speed of travel of the motorized sled between start and stop points along the rail system. The action of starting and stopping the sled can be precisely and repeatedly controlled through the operational controls. In this manner, the camera moves can be made with precision, speed and smooth starts and stops at preset positions and repeated so as to allow multiple repetitions of a specific film sequence during a filming session.

The camera may be mounted and leveled to the horizontal even though the rail system may be angled with respect to the horizon. The drive mechanism for the sled or camera mount may be on board the sled or incorporated into the rail system to provide a reduced weight in the case of cantilevered positioning of the rail system. Curved rails are also contemplated so the position may be varied through a radius in combination with straight-line travel.

The present invention thus generally provides a rail system and a variety of moving mounts, including, but not limited to, platforms, rails, harnesses and mounts. In one embodiment, the moving mount may be a light weight rigid camera platform and rail system that may be used, for example in the film industry, and may be affixed to a moving vehicle such as a car, boat, motorcycle or the like to provide a fixed camera mount or a linear or curvilinear motion to the camera mounting system. It may also be affixed overhead or to the floor or walls adjacent to the film subject thus enabling the camera to be moved during the photography and achieve changing perspective in relation to the subject being photographed.

### BRIEF DESCRIPTION OF THE DRAWINGS

FIG. 1 depicts a rail assembly in accordance with a preferred embodiment of the invention.

FIG. 2 depicts a sled with captive wheels mounted on the rail assembly of FIG. 1.

FIG. 3 is a view of a tensioning mechanism which holds a belt against a drive pulley on the sled of FIG. 2.

FIG. 4 is a perspective view of the ends of two rail assembly segments and an associated mating part.

FIG. 5 is a top view of the arrangement that provides the belt attachment.

FIG. 6 is a top view of an exemplary arrangement in which the ends of the shafts are aligned.

FIG. 7 illustrates the rail and sled coupled to an automobile via a cantilevered mount.

FIG. 8 is a view of an alternative positioning of the drive mechanism fixed to the end of the rail with a belt attached at each end to the sled.

FIG. 9 shows a linear bearing coupled to the shafts.

FIG. 10 depicts a curvilinear rail.

FIG. 11 depicts a wheel assembly for use with the curvilinear rail.

FIG. 12 is a view showing a toothed belt with compressible backing and flexible but rigid mounting backing.

FIG. 13 shows a mounting method of the belt of FIG. 12.

FIG. 14 shows the contact between drive pulley and mounted belt. assembly.

FIG. 15 is a top view of the sled showing the positioning of the drive pulley and tensioning pulleys as they contact the toothed belt.

FIG. 16 shows the arrangement of the camera pivoting attachments to the sled.

FIG. 17 shows the adjustable length attachment of FIG. 16.

FIG. 18 depicts another rail of the invention.

FIG. 19 shows the relationship between the sled, rail and brake system.

### DETAILED DESCRIPTION OF THE INVENTION

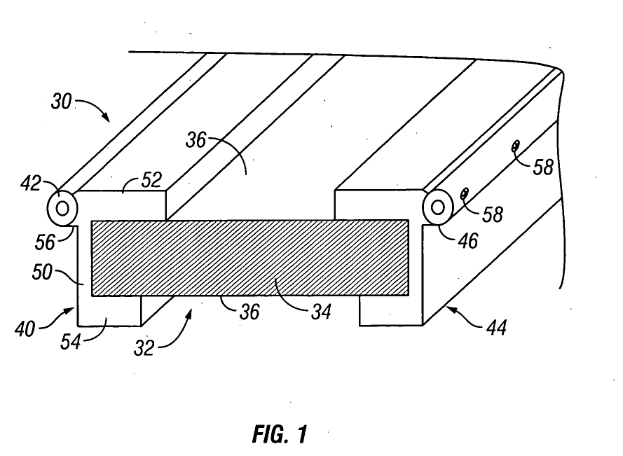

In preferred embodiments, the rail system comprises a rail 30 configured to receive a moving apparatus, such as sled having a platform for mounting a movie camera as shown in the multiple figures. As depicted in FIG. 1, the rail 30 comprises a core 32, positioned between a pair of opposing fixtures 40 and 44 for precision location of a pair of oppositely disposed shafts 42, 46 mounted on respective of the fixtures 40 and 44. The shafts 42, 46 extend along the length of the rail 30 in a longitudinal direction, wherein the shafts 42 and 44 are fixedly mounted on opposing sides of the rail 30 in which the core 32 resides.

Fixtures 40 and 44 are roughly ‘C’ shaped mirror image channels having a base 50, a top flange 52 and bottom flange 54. The top flange 52 and bottom flange 54 are spaced apart by the thickness of the core 32, so that the core 32 is captured in the ‘C’ shaped channel defined by the fixtures. A wedge 56, positioned opposite top flange 52 on the outer side of the base 50, defines a space for secure attachment of the shafts 42 and 46. The shafts 42 and 46 may be attached to the fixtures 40 and 44 by adhesives or welds or removably attached by screws 58. Alternatively, the shafts 42 and 46 may be formed as integral parts of the fixtures 40 and 44.

The rail 30 is preferably made from component materials that are rigid and lightweight. For example, suitable materials include, but are not limited to, the core 32 being formed from a honeycomb aluminum 34 encapsulated by and adhesive bonded to carbon fiber skins 36. However, the core 32 may also be formed from a composite, plastic, carbon fiber composition or a lightweight high strength metal. The core 32 is preferably bonded with high bond strength adhesive to the fixtures 40 and 44. The fixtures 40and 44 are preferably formed from an aluminum extrusion, although the fixtures may be formed from other metals, carbon fiber compositions and even high strength composites or plastics for certain applications of the rail system.

The shafts 42 and 46 are precision diameter aluminum or other high strength metal, plastic or composite materials. The shafts 42 and 46 that are affixed to the fixtures 40 and 44 are shown as being round in cross section, although other shapes such as ovals and even square cross section shafts may be used so long as the shape can accommodate a transport assembly or sled.

The rail 30 is formed by cutting and shaping the core 32 from the honeycomb aluminum 34, plastic, carbon graphite or other suitable material, and applying the carbon fiber skins 36 to the opposing sides using a high strength adhesive. The core 32 is preferably between about two and six inches in thickness and six to twenty eight inches in width. However, for most applications in the movie industry, the core 32 will have a width in the range of six to twelve inches.

The core 32 is placed within and bonded to the fixtures 40 and 44, also using a high strength adhesive. The assembly is then placed in a jig or clamping device to hold the components together while the adhesive cures. The shafts 42 and 46 may be secured to the wedges 56 on the outer sides of the fixtures 40 and 44, for example using screws 58 recessed into the shafts 42 and 46. After the adhesive has cured, the rail 30 is removed from the clamping device.

The rail 30, once assembled, is a rigid and lightweight structure with close tolerance diameter shafts 42, 46 attached longitudinally along the length of each side. A rail system may consist of a number of rails 30 assembled together. While each rail may have the lightweight and rigid core 32 extending along the entire length of each rail 30, in some embodiments, the core 32 does not extend the full length of each rail 30. Also, the core 32 may be hollow or latticed so as to fill only about one-sixth to one half of the space between the fixtures.

The shafts 42 and 46 are affixed to the fixtures 40 and 44 in such a way as to be aligned and to be a fixed distance apart, for example from eight to thirty inches apart but generally eight to sixteen inches apart. The shafts 42 and 46 are straight and parallel to a very close tolerance. For example, the shafts 42 and 46 are preferably parallel to a tolerance of less than 0.01″ over an eight foot long rail 30. The rail 30 constructed as described above is configured to be extremely rigid, and will deflect less than 0.1″ with a 500 lb weight applied at the center of an eight foot rail supported at its ends.

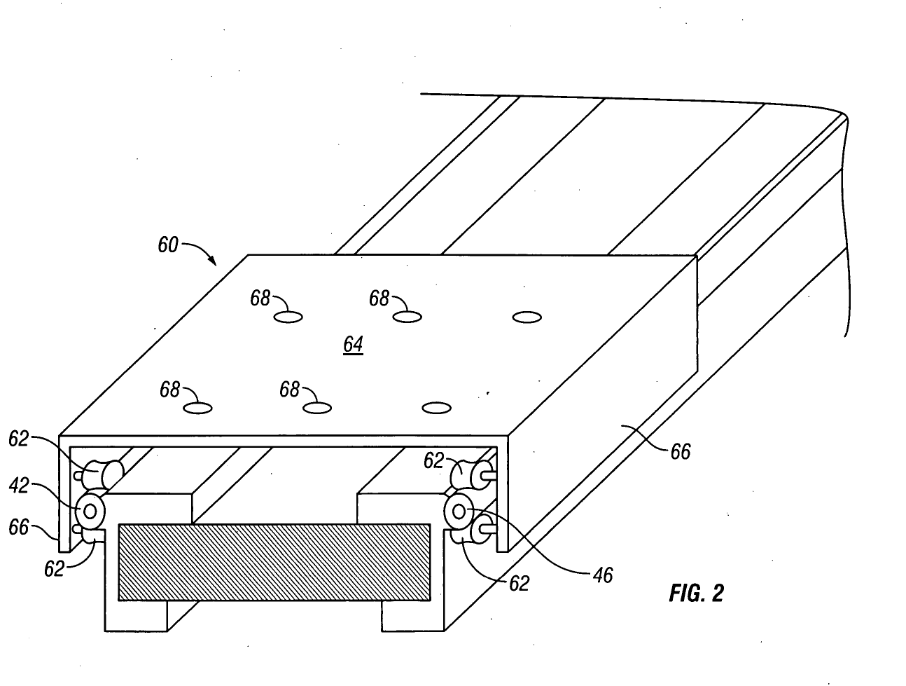

FIG. 2 depicts the rail 30 with a sled 60 secured thereto. The sled 60 has precision wheels 62 contoured to closely fit the shafts 42 and 46 in pairs from above and below with close tolerance. The wheels 62 capture the shafts 42 and 46 of the rail 30 in such a way as to provide smooth traverse of the rail 30 as well as to provide positive fixation of the sled 60 to the rail 30 as well as lateral stability of the sled 60 on the rail 30. The sled 60 and rail 30 may be thus mounted with the sled 60 above or below the rail 30. The rail 30 may be mounted at an angle with respect to the horizontal or even vertically with the sled 60 either fixed in place by locking the wheels 62, or moveable over the length of the rail 30. Also, the rail 30 may be mounted at any angle, for example it may be rotated ninety degrees so that the sled 60 is mounted vertically.

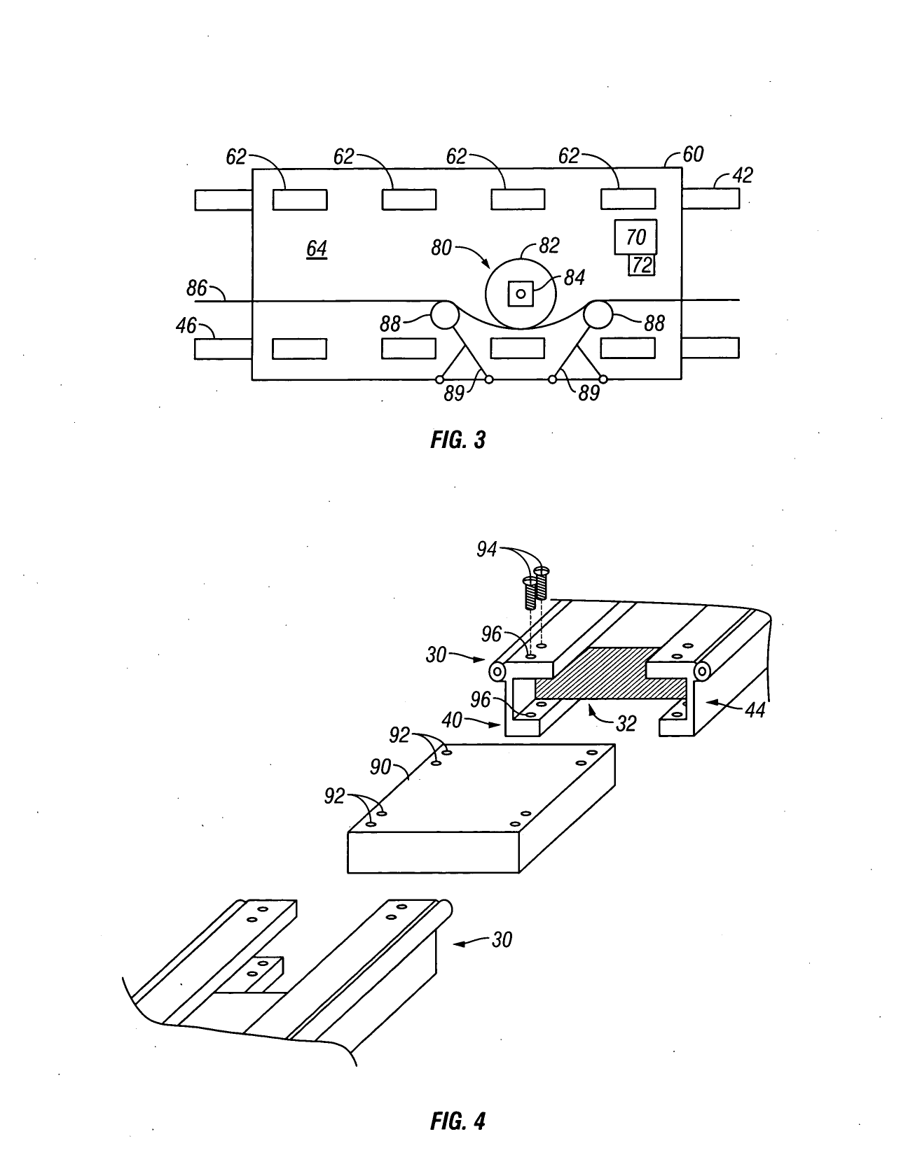

The sled 60 includes a platform 64 spanning the width of the rail 30 and downward depending sides 66. The platform 64 may include one or more tapped mounting holes 68 to allow securement of equipment to the platform 64. The platform 64 and the sides 66 of the sled 60 are preferably formed from aluminum, although other metals and even plastic and carbon graphite composites may be used to fabricate the sled 60. The wheels 62 may be rotationally mounted to the inner surface of the sides 66 as depicted in FIG. 2 or mounted to an extension depending down from the underside of platform 64. While only the wheels 62 at the outer edge of the sled 60 are depicted, the sled 60 may have eight or more wheels 62 on respective sides of the sled 60 both above and below the shafts 42 and 46 as depicted in FIG. 3.

As illustrated schematically in FIG. 3, the sled 60 has a control unit 70, controlling a motorized drive mechanism 80 affixed to the sled 60, to provide a drive force to move the sled 60. The drive mechanism 80 includes a toothed pulley 82 affixed to a motor 84 mounted in such a way as to make contact with a mating toothed fixture or belt 86, so as to drive the sled 60 along the length of the mating toothed belt 86 and traverse the length of the rail 30. In one embodiment, the toothed belt 86 is attached to each end of the rail 30 and tensioned against the toothed pulley 82 by tension pulleys 88 affixed to the sled 60, which are mounted on spring arm assemblies 89. As the motor 84 turns the pulley 82 the sled 60 is pulled against the belt 86 and thus traverses the length of the rail 30.

The control unit 70 affixed to the sled 60 may be operated in such a manner as to control the motor 84 and provide smooth and accurate control over the motion of the sled 60. The control unit 70 may be commanded by the use of an operating system either attached by a wire or through a radio signal received by an auxiliary unit or receiver 72 coupled to the control unit 70 attached to the sled 60. The control unit 70 preferably provides an operator the ability to set precise start and stop positions for the sled 60 so that even though the sled 60 may be far from sight, the operator thus may accurately and remotely drive the sled 60 to the desired position on the rail 30 repeatedly. The control unit 70 further offers the operator the ability to vary the speed of the sled 60 as well as the rate at which the movement starts and stops. The operator of the device may thus remotely control the smooth travel, speed and position of the equipment mounted on the platform 64 of the sled 60, thereby providing the desired precise placement of equipment mounted on the sled 60, for example of a movie camera or other photographic device.

The motor and control unit effectively allows for smooth and precise traverse of the sled 60 over the length of the rail 30. Additionally due to the coupling configuration of the rail 30 and sled 60, the device affords structural integrity and rigidity in the attachment of the sled 60 to the rail 30. Such rigid structural conformity thus allows the placement of the rail 30 in many relationships to the photographic subject and, whether it is vertical, horizontal, angular, cantilevered or suspended, with complete stability of the platform 64 and equipment mounted thereon, such as a camera. The rail 30 and sled 60 prevent lateral vibration of the sled 60 against the rail 30 whatever the angle of mounting the rail 30 may be. The photographic device attached to the sled 60 is thus held in a manner which allows steady images to be recorded and reproduced even while the sled 60 traverses the rail 30 while the entire assembly is mounted on a vehicle moving at a high rate of speed, for example to film a movie chase scene.

The rails 30 are generally formed in six or eight foot segments. However, the rails 30 may be configured so as to be attached end to end to provide an extend length of travel for a sled 60, as shown in FIGS. 4-6. As shown in FIG. 4, each end of the rail 30 may be configured so as to accept a mating part 90, which allows for the rigid and precise alignment of pairs or multiples of rails 30 together. The mating part 90 has a cross section or shape generally equivalent to the cross-section of the core 32, so that it may be captured by the ends of each fixture 40 and 44 of the rail 30 so as to allow each consecutive rail 30 to be joined in a structurally rigid manner. The mating part 90 has tapped holes 92 such that when it is received in the interior of the fixtures 40 and 44 of rail 30, and is positioned adjacent the core 32, it may be attached by screws 94 extending through holes 96 in the fixtures 40 and 44.

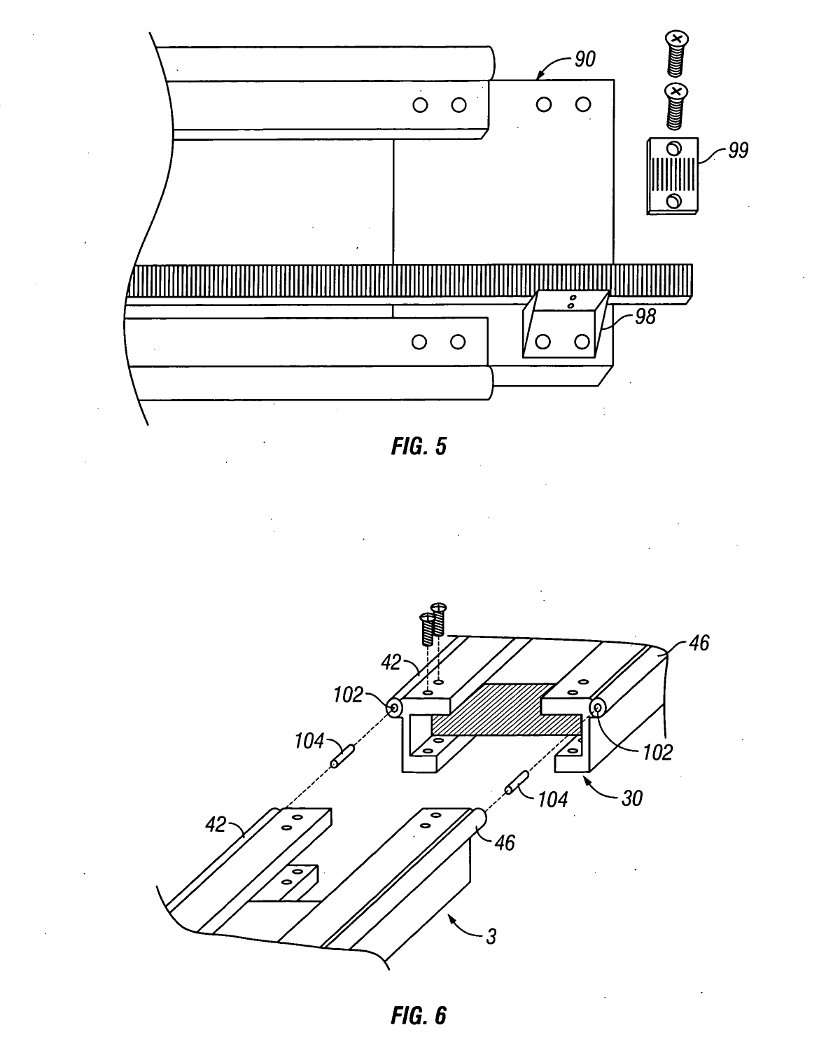

The mating part 90 is coupled to the end of each of the rails 30 such that the rails 30 reside end to end to each other and create a single contiguous rail system. The mating part 90 may include at least one fixed mounting point 98 as shown in FIG. 5 for the attachment of the toothed belt 86, or fixture mating tooth, using a buckle 99. Thus, a mating part 90 at the end of a rail 30 affords a mounting point for the toothed belt 86 which allows the sled 60 to travel. A longer length of belt 86 may be affixed so that the belt 86 extends to the ends of the assembled rails 30 to provide the toothed belt 86 for the sled 60 to pull against. The sled 60 is thus allowed to move any length desired along one or multiple rails 30.

As depicted in FIG. 6, each shaft 42, 46 running the length of each side of the rail 30 has a precision centered axial hole 102 at each end, allowing a precision dowel 104 to be placed in the end of each shaft so as to align the shafts in multiple rails 30. This construction provides alignment of the shafts to be joined and offers a smooth transition for the sled to traverse from one rail segment to another abutting rail segment. This attachment arrangement also allows the rail 30 to be mounted on the floor, overhead or straight up or cantilevered if desired for particular applications. The rails may thus be used vertically or horizontally or at angles to provide motion in a variety of situations and applications.

The rail 30 additionally provides an attachment method to allow the rail 30 to be mounted to a variety of objects easily. Mounting points such as brackets or simply tapped holes on the rail 30 opposite the sled 60 (that is, the top or bottom of the rail) provide attachment points which may be used to hold the light weight rail 30 to other objects through a variety of fixture means. Various methods of attachment exist, including but not limited to the use of bolts and threaded or tapped holes, and other suitable modalities which are capable of bearing the loaded weight of the rail 30 and sled 60 with mounted equipment such as a camera. In preferred embodiments, threaded holes are included on the fixtures 40 and 44 and spaced along the rail 30 providing attachment points for speed rail starters or similar mounting equipment standard to the film trade. Methods typical to the trade may then readily secure and suspend the rail 30 in the desired manner. The rigid cantilever capability of the rail 30, however, provides a unique and distinguishing feature of the invention for the film industry.

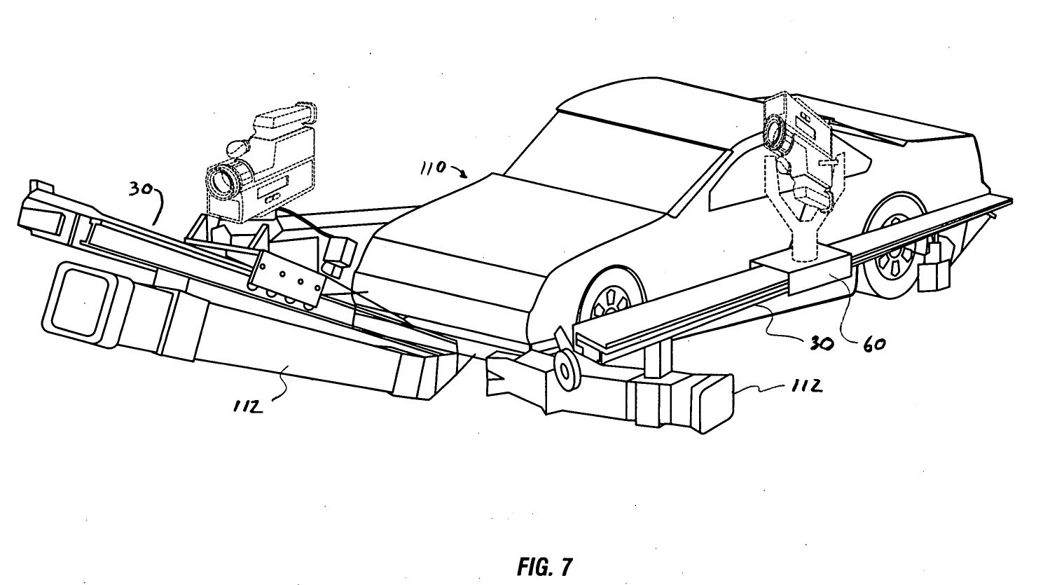

The rails 30 are rigid and lightweight enough that they may be cantilevered off the mounting subject such as an automobile 110 as shown in FIG. 7, and thus provide a changing perspective for filming by traversing the sled 60 away from the mounting point 112. This embodiment is exemplary but other appropriate configurations of rigid and lightweight structures configured so as to allow the change of perspective while traversing away from the mounting point are suitable embodiments of the invention. Alternate mounting embodiments rely upon the distinguishing characteristics of the receding perspective of the photographic device as it traverses away from the subject. The camera mounting system may provide an integral leveling system so that the camera may be adjusted angularly to the subject or horizon, as discussed below.

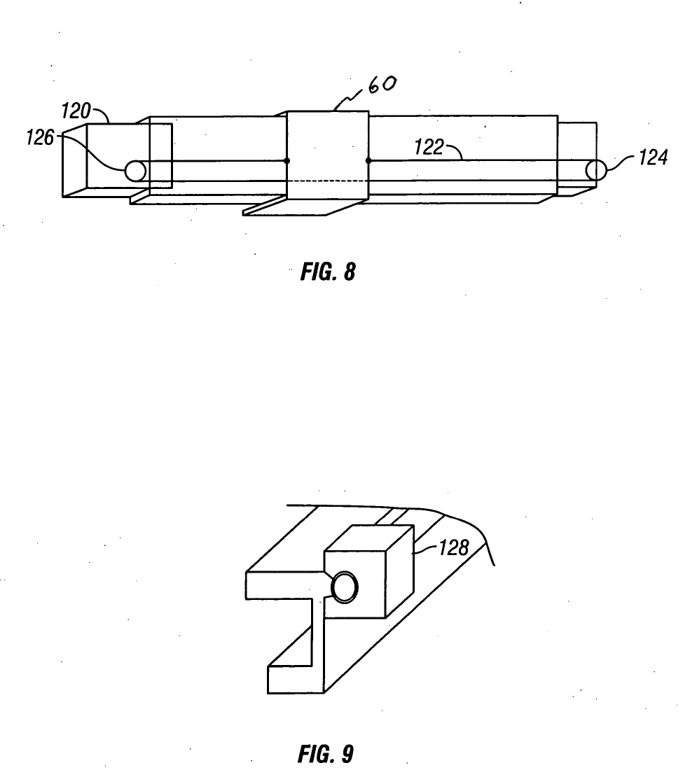

Another embodiment of the sled drive system is depicted in FIG. 8. In this embodiment, a motor 120 may be affixed to one end of the rail 30 and the sled 60 may be pulled either direction on the rail 30 by a belt or cable 122 affixed at its ends to opposite ends of the sled 60. The cable 122 wraps around a pulley 124 mounted on the opposite end of the rail 30 from the motor 120. As depicted, the motor 120 has a drive pulley 126, and may include a tensioning device (not shown). This configuration can be used with multiple rail segments attached end to end by incorporating cables 122 of appropriate lengths. By comparison to the sled mounted motor of FIG. 3, this end mounted motor reduces the weight of the sled 60, yet provides the ability to move the sled 60 either via a remote control or a hard wired control.

Other configurations of the sled 60 and its components for mounting on the rail 30 are contemplated. For example, the precision wheels 62 of the sled 60 may be replaced by open pillow block linear bearings 128 as shown in FIG. 9, to hold position on the rail and provide the moving surface. Those skilled in the art will appreciate that there are many uses and application for the light weight rail 30 and equipment mounting sled 60 described herein. Indeed, while the rail 30 is described as having shafts on opposite sides of the fixtures, a sled which has wheels or the pillow block bearings, the construction may be adapted such that the sled has wheels which capture the fixtures from above and below.

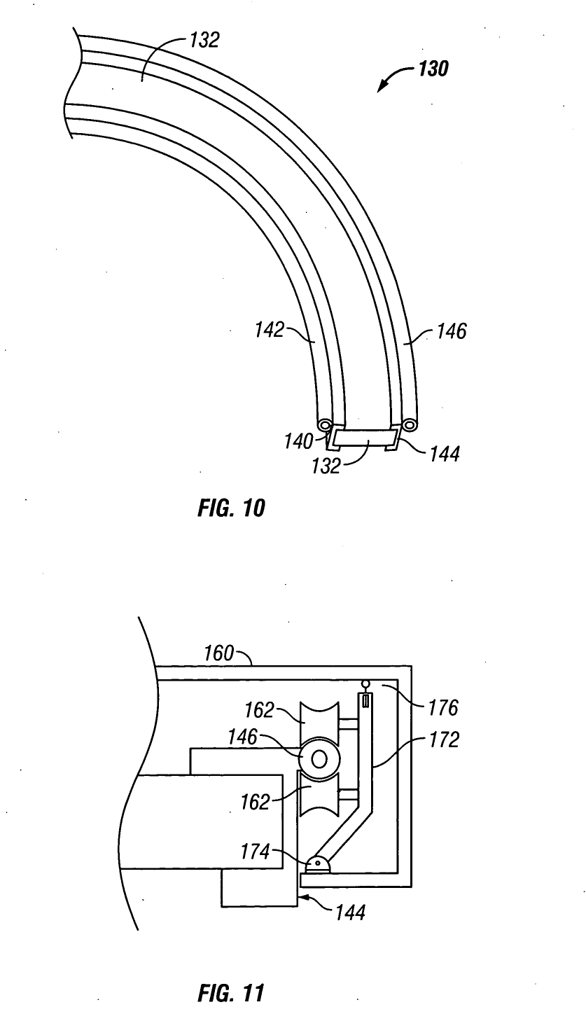

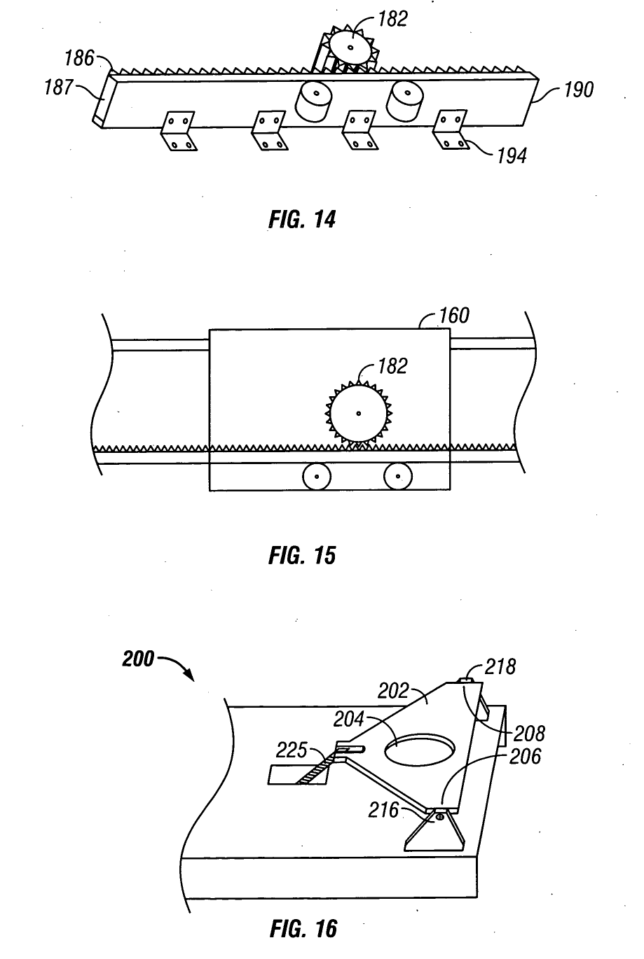

In an alternative embodiment, a curved rail 130 and sled system to achieve curvilinear variance in direction of travel is provided as depicted in FIGS. 10 to 15. The curved rail 130 is constructed in the manner of the first embodiment but in a curvilinear fashion. Thus, the curved rail 130 has a core 132 bound between fixtures 140 and 144 to which shafts 142 and 146, respectively, are attached. The close tolerance shafts 142, 146 are affixed to the fixtures 140 and 144, respectively at the sides of the curved rail 130 with the same center distance held through the arc of the curve as in the parallel rail embodiment. Thus, the two shafts 142, 146 are held in precise relationship through the arc of the curved rail 130.

A sled 160 that may traverse the curved rail 130 must be configured to accommodate the curved rail 130. Thus, the sled 160 has wheels pivotally mounted on the sled 160 to traverse the curve. Each pair (top and bottom) of captive wheels 162 is affixed to the sled 160 via a support 172 in a manner that allows a degree of rotational movement with the support 172 held within pivot(s) 174 having bearings 176. The pivot(s) 174 may also move toward and or away from the centerline of the sled 160, as necessary so as to allow the sled 160 to traverse a small radius arc of the curvilinear track without binding. A mechanism to mount the wheels so as to provide change in angular position in relation to the rails is thus provided to allow the smooth traverse of the radius of the curved rail 130. The curved rail 130 may have straight segments at each end to allow attachment to a straight rail 30, in an identical fashion to the straight connection depicted using mating part 90 as discussed above.

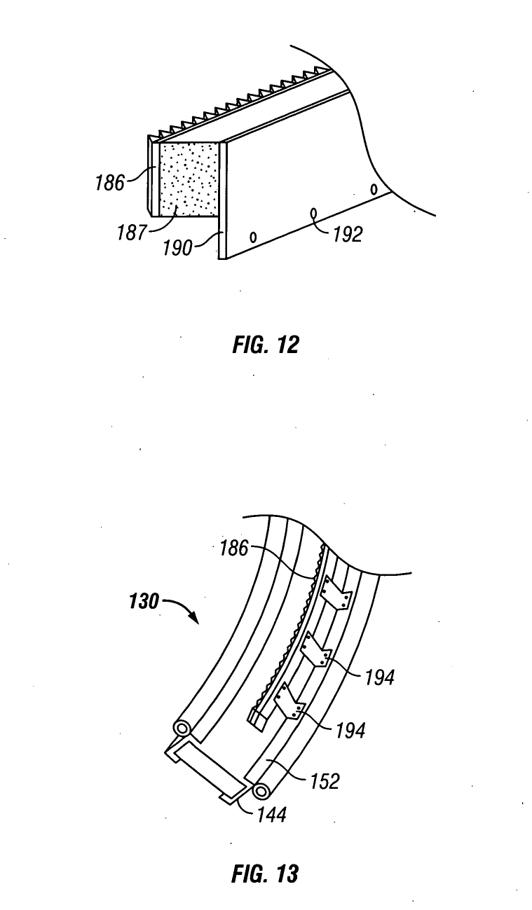

FIGS. 12 to 14 depict the components of a drive mechanism which may effectively drive the sled 160 along the curved rail 130. The drive mechanism described above consists of a mating toothed pulley 82 and matching toothed belt 86, which are configured in a manner as to allow the full contact of pulley and belt along rail 30. To accommodate the curved rail 130, the belt 186 for the curved rail 130 is affixed to a compressible backing material 187 like dense foam rubber or similar material. The belt 186 with backing material 187 is then affixed to a flexible yet rigid backing strip 190 formed from a flexible or hard material such as plastic. The rigid backing strip 190, with belt 186 and backing material 187, is then affixed with screws through tapped holes 192 to the rail 130 by angled attachments 194 secured for example to the top flange 152 of the fixture 144, as shown in FIG. 13, so as to conform to the curvilinear rail system and make contact with the drive pulley 182 on the sled 160.

The engagement between a drive pulley 182 of the sled 160 and belt 186 with the above mounting arrangement is configured so as to force the pulley 182 to compress the belt 186 against the compressible backing 187 and thus conform the teeth of the belt 186 to grooves of the drive pulley 182 thus enabling the drive action. Adjustable tensioning pulleys may also be provided to press the back of the belt assembly to the drive pulley to maintain consistent drive contact as shown schematically in FIG. 15. A similar attachment would be run the length of the straight rail so as to provide a continuous drive system along the straight and curved sections of adjoined rails.

The drive mechanism may also be positioned off the sled 160, at the end of a rail as discussed above with respect to FIG. 8, and a continuous connection between the sled 160 and drive mechanism may pull the sled the length of the respective rails 60 and 160.

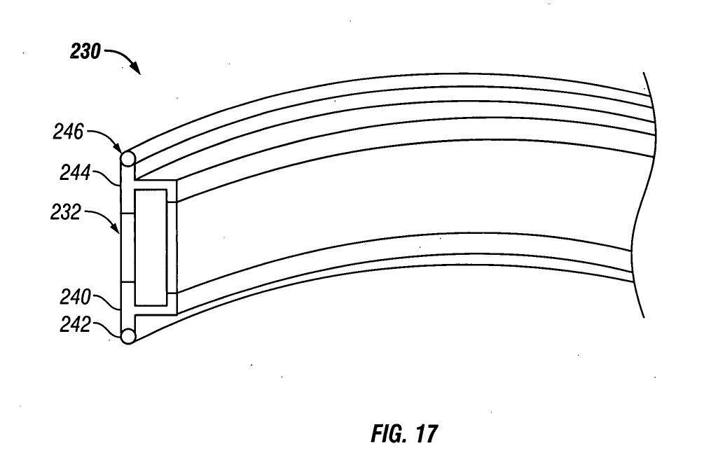

FIGS. 16 and 17 depict a leveling assembly 200 for mounting equipment such as a camera to the sled 60 (or 160). The leveling assembly 200 is beneficial as it may allow for variance of the angle of the camera mount in respect to the rail 30 (or 130). As discussed below, the leveling assembly is mounted to the sled 60 of FIGS. 2 and 3, though it can also be used on sled 160.

As discussed above, the sled 60 has a platform 64 which moves over (or under) the rail 30 to provide a method of attaching equipment such as a camera in such a manner as to allow mounting of the rail 30 at any angle. It is thus also desirable to provide a method of leveling the camera with respect to the horizontal along the length of the rails so as to allow the rails to be placed at an angle in respect to horizontal, or even vertical, while the camera may remain level to the horizon.

The leveling assembly 200 as depicted in FIGS. 16 and 17 thus includes a plate 202 having a generally triangular shape, with camera attachment capability such as a hole 204, mounted to the platform 64 on the sled 60. The triangular plate 202 has two corners 206, 208 affixed in a pivoting yet fixable manner to brackets 216, 218 respectively, mounted to the platform 64. A variable height attachment 220 secures the third corner of triangular plate 202 to the platform 64 affixed in such a manner as to be adjustable in respect to height.

For example, the attachment 220 may include a turnbuckle 222 adjustable on threaded shafts 224, 226 one of which is pivotally secured to the third corner of the plate 202, while the other is pivotally secured to the platform 64. The height of the third corner of the plate 202 over the platform 64 may be adjusted by rotating the turnbuckle 222. The attachment 220 is thus positioned and configured in such a manner as to afford variance of the angle of the plate 202 by raising or lowering one corner of the plate 202 in respect to the opposite edge of the plate 202, which is allowed to pivot. Once the desired angular adjustment is made the plate 202 is secured. This mechanism is aligned on the sled in relation to the travel direction along the rails so as to allow the camera mounting plate it be adjusted along the linear axis of the rail 30. The camera may thus be leveled to the horizon when the rails are placed at any inclination up to vertical. As an alternative, two corners of the plate 202 may incorporate the adjustable attachment 220 to allow variable angles of the plate 202 over the platform 64 and with respect to the rail 30.

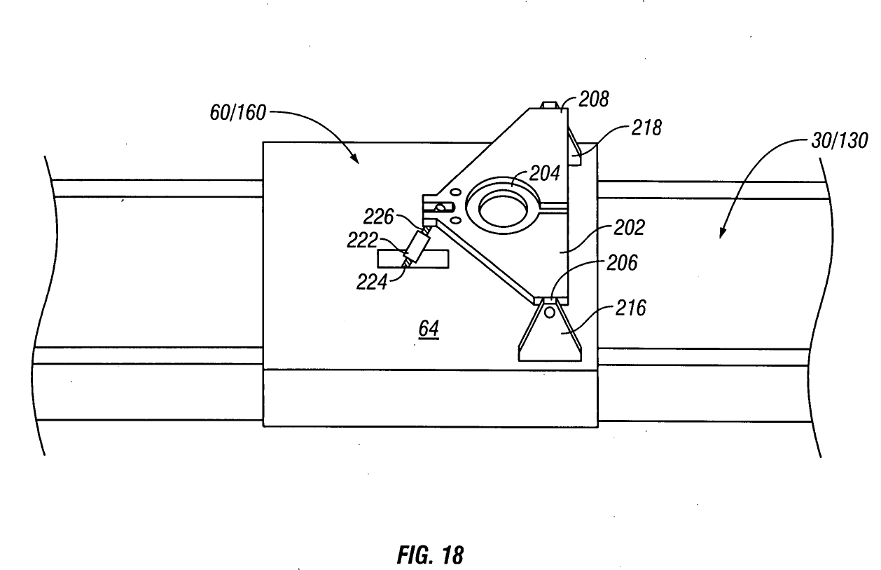

FIG. 18 depicts an alternative curved rail 230 in which the radius of curvature is normal to the axial centerline of the rail 230. In this configuration the core 232, fixtures 240 and 244 and the shafts 242 and 246 are all curved and then assembled to provide a curved rail 230 that may accommodate a sled as described above.

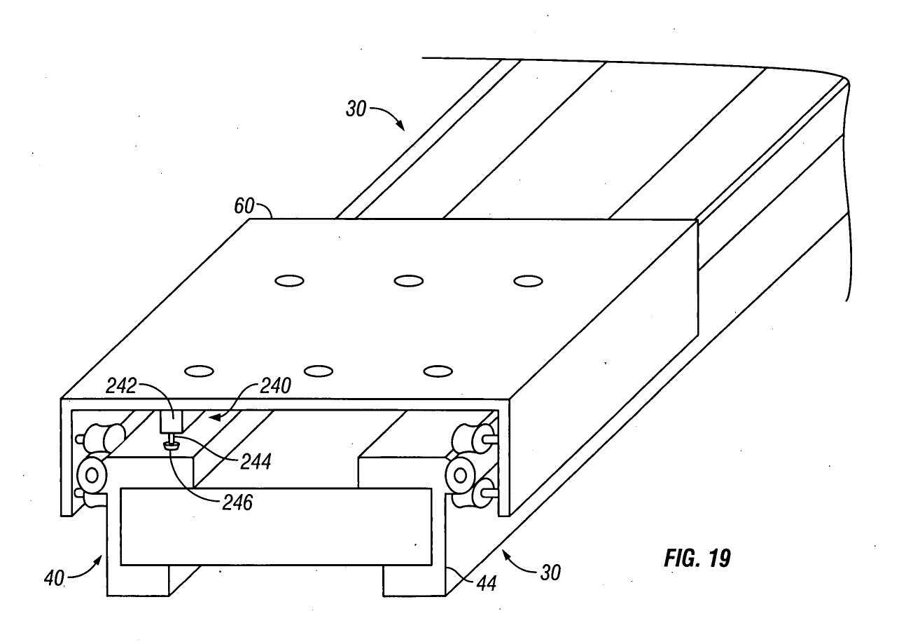

For any of the rail and sled configurations above, it may be necessary to have a means to lock the sled 60 to a position on the rail 30. FIG. 19 depicts a simple brake system 240 which provides added stability to the sled 60 mounted on a rail 30 for when the sled 60 is not in motion. The brake system 240 consists of an electromechanical or pneumatic brake mechanisms activated by the control unit. The brake system 240 applies a force against the fixture 40 of the rail 30 in such a manner as to provide a braking action to the sled 60. The brake system 240 includes a cylinder 242 and piston 244 having a brake pad 246. The cylinder 242 is mounted between the underside of the platform 64 of the sled 60 and the top of the rail 30 in such a manner as when activated, pressure is applied by the brake pad against the fixture 40 thus holding the sled 60 rigid against the rail 30. The control unit 70 is coupled to the brake system 240 to provides the activation of the brake system 240 any time the sled 60 is not instructed to move. The brake system 240 thus provides a more stable stationary platform for camera equipment when it is not moving from one position to the next. The brake system 240 may also be applied on a command from the operator when desired. Thus, the brake system 240 offers a safety mechanism in case of belt failure or other unforeseen event.

From the foregoing detailed description, it will be evident that there are a number of changes, adaptations and modifications of the present invention which come within the province of those skilled in the art. The scope of the invention includes any combination of the elements from the different species or embodiments disclosed herein, as well as subassemblies, assemblies, and methods thereof. However, it is intended that all such variations not departing from the spirit of the invention be considered as within the scope thereof.

1. A rail assembly, comprising:
a core:
a pair of opposing fixtures secured to opposite edges of said core; and
a pair of shafts affixed to said pair of opposing fixtures.

2. The composite rail assembly of claim 1, wherein said fixtures further comprise roughly ‘C’ shaped channels having a base, a top flange and a bottom flange.

3. The composite rail assembly of claim 2, wherein said fixtures further comprise a wedge positioned opposite said top flange on the outer side of said base, said wedge defining a space for secure attachment of the shafts.

4. The composite rail assembly of claim 1, wherein said shafts are formed as integral parts of the fixtures.

5. The composite rail assembly of claim 1, wherein said core is formed from a honeycomb aluminum encapsulated by carbon fiber skins.

6. The composite rail assembly of claim 1, wherein said core is formed from a material selected from the group consisting of aluminum, honeycombed aluminum, composites, plastic, carbon fiber composition and lightweight high strength metal.

7. The composite rail assembly of claim 1, wherein said core is bonded with high bond strength adhesive to said fixtures.

8. The composite rail assembly of claim 1, wherein said fixtures are formed from a material selected from the group consisting of aluminum extrusion, plastic, carbon fiber compositions and high strength composites.

9. The composite rail assembly of claim 1, wherein said shafts are precision diameter shafts formed from a material selected from the group consisting of aluminum, high strength metal, plastic and composite materials.

10. The composite rail assembly of claim 1, wherein said shafts are affixed to the fixtures in such a way as to be aligned and to be a fixed distance to a very close tolerance apart either straight and parallel or curved through an arc and having the same center distance held through the arc.

11. The composite rail assembly of claim 1, wherein said shafts are positioned from eight to thirty inches apart to a tolerance of less than 0.01″ over an 8 foot long rail and said rail is constructed to be extremely rigid deflecting less than 0.1″ with a 500 lb weight applied at the center of an 8 foot rail.

12. A method of forming a rail assembly, comprising:
cutting and shaping a honeycomb core;
applying carbon fiber skins to the opposing sides of said honeycomb core using a high strength adhesive to form a core between about two and six inches in thickness and six to twenty eight inches in width;
placing said core within and bonding said core to fixtures with a high strength adhesive;
securing the resulting assembly in a clamping device to hold the components together while the adhesive cures;
securing shafts to the outer sides of the fixtures; and
removing the rail from the clamping device.

13. The method of forming the rail assembly of claim 12, wherein said shafts are affixed to the fixtures in such a way as to be aligned and to be a fixed distance to a very close tolerance apart either straight and parallel or curved through an arc and having the same center distance held through the arc.

14. The method of forming the rail assembly of claim 13, wherein said shafts are positioned from eight to thirty inches apart to a tolerance of less than 0.01″ over an 8 foot long rail 30.

15. The method of forming the rail of claim 12 constructed to be extremely rigid deflecting less than 0.1″ with a 500 lb weight applied at the center of an 8 foot rail.

16. An apparatus for mounting equipment, comprising:
a rail assembly, having a core, a pair of opposing fixtures secured to opposite edges of said core and a pair of shafts affixed to said pair of opposing fixtures;
a sled mounted on said rail assembly, said sled having a platform for mounting equipment and means for securing said sled to said shafts of said rail assembly; and
a motor and drive assembly for moving said sled along said rail assembly.

17. The apparatus of claim 16 wherein said motor and drive assembly further comprises a control unit and a remote control receiver to control said motor and thereby the position of said sled on said rail assembly.

18. The apparatus of claim 16 wherein said shafts are affixed to the fixtures in such a way as to be aligned and to be a fixed distance to a very close tolerance apart either straight and parallel or curved through an arc and having the same center distance held through the arc.

19. The apparatus of claim 16, further comprising:
a leveling assembly secured to said platform of said sled, said leveling assembly including a plate having at least one corner pivotally secured to said platform and at least one other corner secured to said platform by an apparatus for changing the spacing of said other corner from said platform.

20. The apparatus of claim 16, further comprising:
a brake system to secure the position of said sled on said rail assembly.

21. The apparatus of claim 16, further comprising:
a mating part to allow sections of said rail assembly to be secured together to form an extended length rail assembly.

22. The apparatus of claim 16, further comprising:
attachment means to allow said rail assembly to be secured to a transportation device to transport said rail assembly and said sled while said motor drive assembly moves said sled along said rail assembly.
